(19) United States
(12) Patent Application Publication
(10) Pub. No.: US 2017/0330490 A1
(43) Pub. Date: Nov. 16, 2017

(54) SMITH SECURITY SEAL

(71) Applicant: Hal Bradley Smith, Sneads Ferry, NC (US)

(72) Inventor: Hal Bradley Smith, Sneads Ferry, NC (US)

(21) Appl. No.: 15/154,971

(22) Filed: May 14, 2016

(51) Int. Cl. G09F 3/03

(52) U.S. Cl. CPC G09F 3/0358

(57) ABSTRACT

The present invention provides a wire and insert seal which advantageously provides visible evidence of tampering therewith and/or tampering with the device to which the seal having a hollow body is attached with a moveable insert to block molded openings of where the key is inserted. Due to its flexibility, the present invention requires a minimal amount of steps to install.

### BRIEF DESCRIPTION OF THE DRAWINGS

For better understanding of the present invention, together with other and further objects and advantages, reference is made to the following description, taken in conjunction with the accompanying drawings, and its scope will be pointed out in the appended claims.

The key includes a body housing having a moving end portion blocking off the access opening with at least one wire notch, and a locking mechanism capable of permanently closing key by preventing access to inside the body housing to prevent tampering of the seal.

FIG. 1 is a bottom plan view of the body of a preferred embodiment of the present invention with a protrusion; FIG. 2 is a perspective view of the second piece of the present invention forming a cavity which accommodates the entry of both legs of the wire hasp and which provides the catch for the spring action of the wire to expand;

FIG. 3 is a perspective view of the next piece forming a cavity to accommodate the entry of the folded left leg of the wire hasp and moves through the left channel of the present invention; FIG. 4 is a perspective view of the next sequential piece forming of the present invention;

FIG. 5 is a top plan view of the body of the present invention; FIG. 6 is a bottom view of a sequential stacked piece of the moveable insert where the left side depicts a pathway for the left leg of the hasp to enter the seal body from the top; FIG. 7 is a middle view of the next sequential stacked piece creating the pathway for the folded over end of the left leg of the hasp to enter the seal body from the top and moves creating tension on the wire;

FIG. 8 is a top view of the stacked piece where the left side reflects a small spring-loaded tab molded to extend downward to FIG. 6; FIG. 9 is a top plan view of the wire hasp forming a “U” shape with the left leg longer than the right leg having a spring loaded bent; FIG. 10 is a view of FIG. 9 from the left and right;

FIGS. 11 through 18 are a schematic representation of the system of the first preferred embodiments where a seal body is adapted for use with a wire hasp consisting of a hollow housing having sequential stacking of at least one intermediate piece at least one pathway extending between the intermediate pieces of the top and bottom ends for passage of a wire through the housing, each of the intermediate piece walls defining an entrance opening to the pathway including an access opening in the front end of the housing; and a wire retaining key, which is sized and shaped for insertion into the keyway.

FIG. 11 is a cross-sectional plan view of the housing depicting how the wire is installed; FIG. 12 is a cross-sectional plan view of the housing depicting the wire insert pressed into the seal body of the present invention; FIG. 13 is a cross-sectional view of the housing reflecting a clear path for the wire from the top of the seal to the bottom; FIG. 14 is a cross-sectional view of the housing reflecting a blocked entry at the top providing the catch for the doubled over end of the wire being held in place;

FIG. 15 is a partial cross-sectional view illustrating both legs of the wire being pressed in accordance with the present invention; FIG. 16 is a partial cross-sectional view illustrating the right leg of wire insert cannot be pressed back in due to the position of the left leg;

FIG. 17 is a partial cross-sectional view illustrating the small tab at the bottom of the seal residing in the seal body and blocks the opening molded in the seal body of the housing; and

FIG. 18 is a partial cross-sectional view of the housing illustrating the wire hasp insert pulled to the top of the seal as shown in both FIGS. 16 & 17.

### DETAILED DESCRIPTION OF THE PREFERRED EMBODIMENTS

The following description of the preferred embodiments of the invention is intended to enable someone skilled in the prior art to make and use this invention, but is not intended to limit the invention to these preferred embodiments.

Referring to the drawings, which are pieces of both a seal body and insert with each layer approximately the thickness of a wire hasp.

As shown in FIG. 1, the system of the preferred embodiments is a bottom of the seal body with a protrusion where FIG. 2 is a second piece of the seal body present forming a cavity, which accommodates the entry of both legs of a wire hasp and portions of the moveable insert.

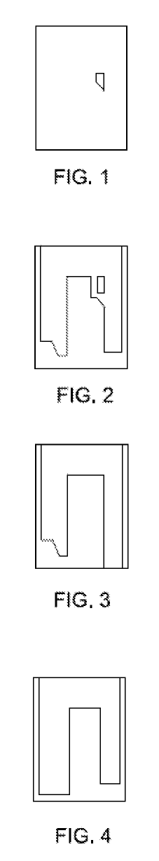

FIG. 3 is a next piece of sequential stacking of the body forming a cavity to accommodate the moveable insert and provides movement of the bend end of at least one of the legs of the wire hasp.

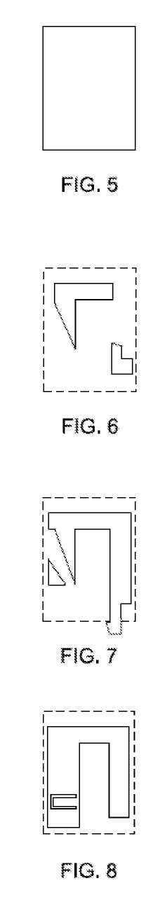

FIG. 4 is a next sequential piece forming a cavity to accommodate the moveable insert while FIG. 5 is a top plan view of the body of the present invention;

Also reflected in the drawings is the configuration of the wire hasp, which is depicted in FIGS. 9 & 10.

The hasp is generally “U” shaped with a left leg slightly longer than a right leg and the right leg employs a conventional spring loaded bent end while the left leg employs no spring action, but rather is simply folded over and pressed firmly against the leg and cut to the appropriate dimension to engage the catch molded in the insert as shown in FIGS. 14 & 17.

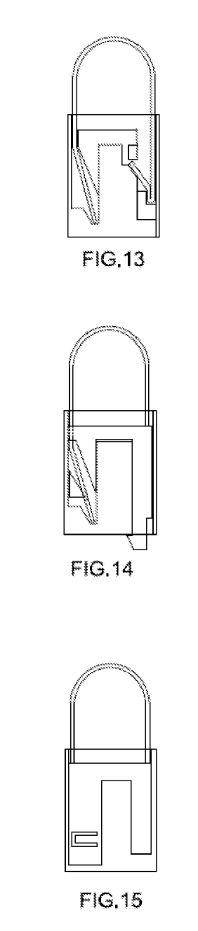

The spring loaded right leg is non-conventional in that the end is pinched such that it will fit snuggly into the cavity molded in the seal insert as shown in FIGS. 13 &16.

Note also the orientation of the left leg's end as it is positioned 90 degrees from the orientation of the right leg. In other words, with the hasp laying on a flat surface, the bend in the end of the right leg is turned to the left while the bend end of the left leg is turned up.

To construct a three-dimensional (3D) depiction of the seal body, pieces of FIGS. 1-5 are stacked sequentially one on top of the other with FIG. 1 on the bottom and FIG. 5 on the top. The internal cavities, channels and catches within the seal body are created in the molding process by (1) a single mold insert (slide) entering from the top of the seal body and (2) a small quadrilateral shaped protrusions in the bottom half of the mold. Note that the small protrusion only extends up through pieces FIGS. 1 & 2 and that it creates a cavity in piece FIG. 2, which is the level that accommodates entry of the right leg of the wire hasp and which provides the catch for the spring action of the wire to expand and then as the hasp and the insert are pulled outward, the end of the wire is forced into the small channel created by the mold insert/slide as shown in FIGS. 13 & 16.

While a small portion of the wire can be accessed via a small hole in the seal body, the wire ends cannot be recompressed or otherwise moved for removal as long as the other leg of the hasp holds the insert in locked position. The length of the wire from the pinched end to the end of the wire must be of appropriate length to wedge the wire between the right wall of the entry channel and the left wall of the small channel, which captures the end of the wire, thus making it impossible to pull the wire out without damaging the seal body. In other words, the right wall of the entry channel should be engineered to fracture if sufficient force is applied.

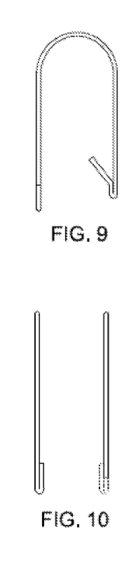

To construct a 3D depiction of a moveable insert, pieces of FIGS. 6-8 are sequentially stacked one on top of the other with FIG. 6 on the bottom and FIG. 8 on the top with the dotted lines reflect the seal body. The configuration is created with a single two-part mold.

The left side of FIGS. 6 and 7 depict a pathway created for the left leg of the hasp to enter the seal body from the top and move in such a manner as to create a tension on the wire as it is forced to move to the right as shown in FIGS. 13 & 14 and then when pulled outward the tension is released thus allowing the doubled over end of the wire to move back left to engage the ledge in the bottom of the seal body and the catch in the insert.

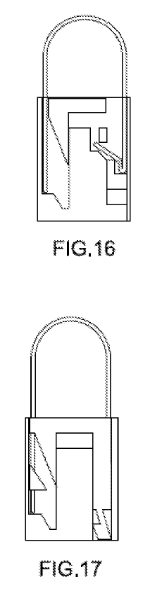

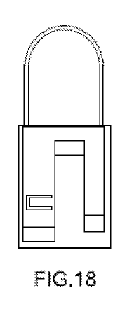

The doubled over end of the wire follows the incline to the right in FIG. 14, but moves back slightly left when the wire is pressed all the way in thus engaging the corner of the insert catch and making it possible to pull the insert outward and into a locking position as shown in FIGS. 16 & 17.

The left side of piece of FIG. 8 reflects a small spring locked tab that is molded to extend down to piece of FIG. 6 and is designed to flex up as the wire passes under it and then return to its molded position when the wire moves beyond it thus blocking the wire from moving back to the right. With this tab in position, there is no way to remove the wire.

FIG. 13 reflects a clear path for the wire from the top of the seal to the bottom while FIG. 14 reflects a blocked entry at the top and provides the catch for the doubled over end of the wire to be held in place.

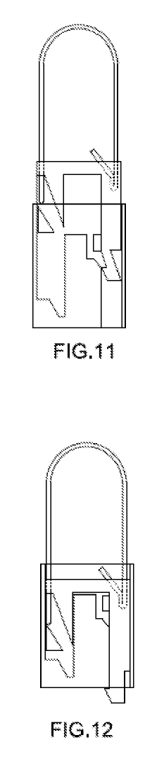

FIG. 12 depicts how the wire must be installed during manufacture. The insert will be partially inserted with the wire in place as shown in FIG. 11 and then the insert is pressed all the way into the seal body as shown in FIG. 12.

The small tab on the bottom of the right leg as shown in piece of FIG. 7 is configured with a flexible catch and that the tab compresses as the insert is being pressed in FIG. 11 and then flexes outward once the insert is all the way in FIG. 12, thus allowing the catch to engage the outside of the seal body and hold the insert in place during shipment and until it is installed on a facility by the customer.

The position of both legs of the hasp in FIG. 12 for shipment to the customer is at the bottom of the seal with both legs of the wire extend a part way in, the left leg is captured within the seal body by a catch in the insert, while the right leg is held in a secure position, but easily removed for installation on a facility by the customer. When the customer is ready to install the seal, the right leg, which is only partially inserted in the seal body for shipment, is pulled out and passed through the facility to be sealed and then to activate the locking mechanism the installer must then release the small locking tab extending beyond the bottom of the seal body as shown in FIG. 14 and then pull the wire and insert upward/outward as shown in FIGS. 16, 17, & 18.

Once the seal is in locked position, the small tab at the bottom of the seal resides in the seal body (FIG. 17) and blocks the opening molded in the seal body and thus blocks access to the inside of the seal.

Alternatively, the seal design could be shipped to the customer as three parts (body, insert & hasp) thus allowing the customer to assemble it at the time of installation. This approach would not only represent a savings from a manufacturing standpoint, but would also allow those customers who utilize color coding to maintain supplies of various colors of just the insert rather the entire seal.

The insert reduces the opening in the top left side of the seal body (FIG. 13) to the size of the diameter of the wire and is thus totally obstructed by the wire. The passage way on the right for the right leg of the wire hasp is open (piece of FIG. 6); however, the spring end of the hasp is secured by its position within the seal body such that it cannot be recompressed, pressed back down or otherwise removed without leaving evidence of tampering as shown in FIG. 16.

In FIG. 2, the small center channel created by the top insert/slide intersects with the small quadrilateral shaped hole molded in the seal body and thus creates a secure catch for the spring end of the wire hasp. As positioned in FIG. 16, the right leg and insert cannot be pressed back in due to the position of the left leg, which has snapped left and engaged the ledge in the seal body. The left leg cannot move back to the right due to the blocked access to the internal workings and the small tab (SEE FIG. 8), which holds it in locked position, nor can it be pulled out as there is no open exit.

When properly installed and in locked position, the left leg will not allow the insert to be pressed back in and the right leg will not allow the insert to be pulled out (SEE FIGS. 16 & 17). Each leg is dependent upon the other to maintain the integrity of the locking mechanism of the seal; however, there is no opportunity to release either leg once it is locked without damaging the seal body.

Given the above-described unique construction of the wire hasp and seal body of the present invention, the novel operation of the wire hasp and seal body will now be explained. The non-conventional configuration of the wire hasp at the end is turned in on the right leg but is pinched, while the left leg is turned up and is simply doubled over and does not employ a spring action. The configuration of the body and insert are such that they force the left leg to move right thus creating a tension on the wire that allows it to snap back left when pulled out thus engaging the ledge in the seal body and the catch in the insert and preventing the insert from being pressed back in or pulled out. The seal body utilizes a small spring-loaded tab as part of the insert to secure the left leg once it snaps to the left. When the tab snaps into position, the left leg cannot move back to the right.

Other exemplary illustration of the seal body only requires one mold insert/slide to create the necessary internal configuration within the seal body. The seal design creates a portion of the internal catch by molding a small hole from the outside of the seal body without compromising the integrity of the seal as the small hole provides no useable access to unlock the seal.

Advantages of the seal design are that the body cannot be picked or compromised without damaging the seal. Also, the seal design cannot be cannibalized to create a useable seal by using parts from multiple seals, as the body will always be damaged to remove the wire and insert.

Another embodiment of the single slide design utilizes the general configuration of the right leg of the wire hasp and corresponding catch, but rather than employing a moveable insert, the left leg of the wire hasp is configured such that installation into the seal body creates the required tension to trigger the locking mechanism and is also configured to capture and secure the pinched end of the right leg of the wire hasp.

Another preferred embodiment of the present invention is a two- slide design body and seal insert. The configuration of the wire hasp is generally “U” shaped with the wire ends turned rather than in as in with most conventional designs. The pieces of the both the seal body and insert are stacked sequentially one top of the other. The internal cavities, channels and catches within the seal body are created in the molding process by (1) a mold insert (slide) entering from the top of the seal body and (2) a mold insert (slide) entering from the left side.

A catch is created in the seal insert that captures and secures the spring ends of the wire hasp as the insert is pressed into a locking position. The internal configuration within the seal body captures and secures the portion of the wire leg that enters the seal body by holding the insert in a locked position. The configuration allows the moveable insert to block the molded openings in the seal body as the insert moves into a locked position, thus preventing access to the internal workings and locking mechanisms of the seal.

The left slide creates most of the internal cavity, but is configured such that a single layer is created by the top slide, along with the two channels to secure the wire. The configuration of the top slide is required to provide the slide with enough rigidity to support the two long bars, thus avoiding problems that may arise in the manufacturing process if the two channels were created by just two long bars that are not connected.

To construct a 3D depiction of the moveable insert, the pieces are sequentially stacked one on top of the other. The configuration is created with a single two-part mold. A channel is created to accommodate entry of the wire hasp and when aligned with the entry slots in the seal body, the seal insert extends outside of the seal body. The depth of the entry channel is such that the spring ends of the wire hasp are held compressed. The design of the channel to the left of the entry channel is greater than the depth of the entry channel, thus creating a slot for the spring ends of the wire hasp to snap into when the insert is pressed into the seal body. The left channel does not extend to the outside of the insert, thus creating a catch for the ends of the wire.

Another embodiment of the two slide design features the mold slides entering from the bottom and the left side, with the left slide creating a catch and the bottom slide creating the cavity for a moveable insert and a small passageway in the top of the seal for the wire hasp to enter the seal body. The wire hasp is generally “U” shaped with the ends turned in to form a hook, but do not employ a spring action. The locking mechanism is incorporated into the moveable insert via locking tabs that engage the catch in the seal body. Movement of the insert positions the hook shaped ends of the hasp behind molded obstructions in the seal body and the locking tab holds the hasp in a secure locked position. Access to the internal workings of the locking mechanism is totally blocked due to movement of the insert in conjunction with the unique configuration of the seal body, insert and wire hasp.

Another embodiment of the two slide design features the mold slides entering from the top and the right side, with the right slide creating an internal catch and the top slide creating the cavity for the moveable insert. This embodiment employs a conventional wire hasp with the ends turned in and spring loaded such that they compress on entry and expand to engage a catch inside the seal body. The design provides for both legs of the hasp to be snapped into the insert before the insert is pressed into the seal body. When the insert, with the wire attached, is pressed into the seal body, the spring ends of the wire expand and engage the internal catch. The wire holds the insert in a locked position and the configuration and movement of the insert blocks all access to the internal workings of the locking mechanism.

Alternative embodiment is to mold the entry channel with a slight incline to facilitate movement of the spring ends of the hasp into the deeper slot as the moveable insert is pressed into locking position.

When the customer installs the seal, he must simply remove the right leg from its temporary position in the top slot of the seal body and then, after placing it on the desired facility, reinsert the right leg into the top slot and press both legs of the wire hasp all the way into the seal body. To lock the seal, then press the moveable insert all the way into the seal body. This action will align the spring ends of the wire hasp with the deep slot in the seal insert, thus allowing the spring ends of the wire to snap into the slots.

In this locked position, (1) the wire cannot be pulled out as the spring ends are captured deep within the insert and movement of the insert has totally blocked exit from the slots in the top of the seal body, and (2) the insert cannot be pulled back out as there is nothing exposed to grasp to pull on, plus the insert is secured in its position by the full length of the wire hasp which is captured in the channels molded in the seal body.

Another exemplary illustration of the seal body creates a portion of the internal catch by molding a small hole from the outside of the seal body; however, doing so does not compromise the integrity of the seal as the small hole provides no useable access to unlock the seal.

Another exemplary illustration of the seal body utilizes a small flexible tab that extends out the bottom of the seal to temporarily hold the insert in place. The opening is obstructed once the seal is installed and locked. The seal body also utilizes the concept of wedging the end of the wire in a confined space to secure it and prevent removal.

Yet another exemplary illustration of the results of an attempt at tampering with the wire and insert is that the body will always be damaged. Again, the wire and insert cannot be picked or otherwise compromised without damaging the seal. The resulting damaged seal cannot be cannibalized from multiple seals to create a useable seal, and, thus, negates the perpetrator's attempts to mask his tampering with the equipment or item to which the wire and insert are attached.

As a person skilled in the art will recognize from the previous detailed description and from the figures and claims, modifications and changes can be made to the preferred embodiments of the invention without departing from the scope of this invention defined in the following claims.

What is claimed is:

1. A seal body adapted for use with a wire hasp, comprising:
a housing having stacking of a bottom end, at least one intermediate piece, a top end, a front end, and a back end, with at least one pathway extending between said intermediate pieces of said top and bottom ends for passage of a wire through said housing, each of said intermediate piece having a wall defining an entrance opening to said pathway including an access opening in said housing; and
a wire retaining key which is sized and shaped for insertion into said access opening, said key including a body housing having a moving end portion blocking off said access opening including at least one wire notch, and a locking mechanism capable of permanently closing said key by preventing access to inside said body housing to prevent tampering of said seal.

2. The seal of claim 1 wherein a moving insert positions the wire and blocks access.

3. The seal of claim 1 wherein said housing includes an entry channel designed to fracture when force is applied.

4. The seal of claim 3 wherein said housing is created in a molding process.

5. The seal of claim 1 wherein said wire hasp has spring ends of at least one of legs is turned up.

6. The seal of claim 5 wherein one of said legs is pinched and other leg is doubled over without employing a spring action.

7. The seal of claim 1 wherein said housing has at least one internal cavity, channel, and catch.

8. The seal of claim 1 wherein said housing having a small quadrilateral shaped protrusions extending through at least two pieces creating a cavity, which at least of one of said pieces accommodates entry of at least of one leg of said wire hasp; and said cavity provides said catch for a spring action of wire to expand, which then as said hasp and an insert are pulled outward, the end of said wire is forced into a small channel created by said top piece mold.

9. The seal of claim 7 wherein said housing an insert is configured to force a left leg of said wire hasp to move right by creating a tension of said wire allowing said wire to snap back left when pulled out by engaging a ledge in said seal body and a catch in the insert, and the positioning of the right leg, which prevents said insert from being pressed back in or pulled out said seal.

10. The seal of claim 7 wherein said channel has a small center created by said top end intersecting with said small quadrilateral shaped hole molded in said seal body, thus creating a secure catch for a spring end of said wire hasp.

11. The seal of claim 7 wherein said wire ends cannot be recompressed or otherwise moved for removal while other end of said hasp holds said insert in locked position.

12. The seal of claim 1 wherein said pathway created for said left leg of said hasp to enter said seal body from the top and move in such a manner creating a tension on said wire as said wire is forced moving to the right and then pulled outward said tension is released, thus allowing a doubled over end of said wire to move back left to engage a ledge in said bottom of said seal body and said catch in said insert.

13. The seal of claim 1 wherein said wire comprising a generally U-shaped hasp having a left leg slightly longer than a right leg and said right leg employing a conventional spring loaded bent end while said left leg employs no spring action, but rather is simply folded over and pressed firmly against said left leg.

14. The seal of claim 10 wherein an end of said spring loaded right leg is pinched to fit with clearance avoiding removal after insertion into said cavity molded in said seal insert and an end of said left leg is positioned 90 degrees from the orientation of said right leg.

15. A seal as described in claim 12 wherein said pathway on the right side for said right leg of said wire hasp is open, however said spring end is secured by its position within said seal body, which cannot be recompressed, pressed back down, or removed without leaving tampering evidence.

16. A seal as described in claim 1 wherein the insert reduces the opening in said top left side of said seal body is the size of said wire's diameter and is thus totally obstructed by said wire.

17. A seal as described in claim 1 wherein a moveable insert is created with a single two-part mold.
